(19) United States
(12) Patent Application Publication
(10) Pub. No.: US 2014/0326053 A1
(43) Pub. Date: Nov. 6, 2014

(54) METHOD FOR TESTING THE HERMETIC SEALING OF PACKING

(71) Applicant: Miguel Mendoza Machain, Monterrey (MX)

(72) Inventor: Miguel Mendoza Machain, Monterrey (MX)

(73) Assignee: AUTOMATED DATA SYSTEMS S.A. DE C.V., COLONIA CENTRO MONTERREY, NL (MX)

(21) Appl. No.: 13/807,313

(22) PCT Filed: Jun. 28, 2011
(86) PCT No.: PCT/MX11/00078

§ 371 Date: May 15, 2013

Related U.S. Application Data
(60) Provisional application No. 61/359,016, filed on Jun. 28, 2010.

(51) Int. Cl. G01M 3/36

(52) U.S. Cl. CPC G01M 3/36
USPC 73/49.3

(57) ABSTRACT

A method for testing the hermetic sealing of packages, comprising subjecting the package to two or more moderate depressurization cycles in order to cause stress to the package followed by a final depressurization step at a high negative pressure in order to reveal possible failures and air leaks.

### BACKGROUND OF THE INVENTION

A. Field of the Invention

The present invention relates to methods for testing the hermetic sealing of packages and more particularly to a method for testing the hermetic sealing of packages by subjecting the package to two or more cycles of moderate depressurisation in order to cause stress on the package and a final depressurization step at a high negative pressure to reveal possible failures and leaks in gaskets.

B. Background of the Invention

There are several methods and apparatuses well known in the art for testing the hermetic sealing of various types of hermetic packages, such as submerging the packages in a container filled with water and applying a negative pressure, subjecting the packages to a negative pressure and detecting pressure changes within the package, applying a positive pressure to the package and detecting pressure changes inside the package, etc.

For example, the Mexican patent No. 9708328 describes a method and apparatus for evaluating the hermetic sealing of various types of hermetic packages, that combine a negative pressure (vacuum) which tries to get out of the package, with a positive pressure (weights) which speeds up the operation. The packages to be evaluated are placed inside an apparatus comprising a vacuum chamber having a base on which are mounted evaluator poles beneath which are placed the packages, which are subjected to a negative pressure (vacuum) and are thus expanded, thus raising the poles, which have a weight at one end that exerts pressure on the packages in order to accelerate the exit of air through any existing leak.

The main disadvantage of the method described in the Mexican patent No. 9708328 and of the aforementioned methods is that the hermetic packages are tested against leakage when in optimum conditions, i.e. recently sealed and before being subjected to any stress condition, for example during transport, constant atmospheric pressure changes when the packages are transported between different cities altitude, rubbing against other packages or items, etc. and it is during these real conditions when defects in the material and sealed seams may arise, which could not be detected during testing and it can cause that the package may lose its tightness.

In view of the above referred problem, applicant developed a method for testing the tightness of packages, which subjects the packages to one or more cycles of moderate depressurization to cause stress, and to a final depressurization step at a high negative pressure to exacerbate stress points or deformations in the material or in the sealing seams and discover defects in material and/or sealing seams which would not be possible to discover with traditional testing methods.

Additionally, thanks to the one or more moderate initial pressurization cycles, it is possible to carry out a simulation of the transportation of the packages, in order to test the tightness thereof by generating several vacuum pressure values within a sealed chamber during predetermined time periods for each change of vacuum pressure, thus simulating the actual of the product in transit at different altitudes above sea level thus to verify that there are no air leaks in packages for each vacuum pressure and to observe the performance of the package or several packages in varying heights relative to sea level, and physical accommodations in a given area (inside the chamber), which allows to evaluate the performance of the packages within the real containers during transit to their final destination by applying one or more vacuum pressure cycles having different durations.

### SUMMARY OF THE INVENTION

It is therefore a main object of the present invention, to provide a method for testing the hermetic sealing of packages, comprising subjecting the package to two or more moderate depressurization cycles in order to cause stress to the package followed by a final depressurization step at a high negative pressure in order to reveal possible failures and air leaks.

It is still an additional object of the present invention, to provide a method for testing the hermetic sealing of packages of the above referred nature, which subjects the packages to one or more cycles of moderate depressurisation to cause stress, and to a final depressurization step at a high negative pressure to exacerbate stress points or deformations in the material or in the sealing seams and discover defects in material and/or sealing seams which would not be possible to discover with traditional testing methods.

It is still an additional object of the present invention to provide a method for testing the hermetic sealing of packages of the above referred nature, in which thanks to the one or more moderate initial pressurization cycles, it is possible to carry out a simulation of the transportation of the packages, in order to test the tightness thereof by generating several vacuum pressure values within a sealed chamber during predetermined time periods for each change of vacuum pressure, thus simulating the actual of the product in transit at different altitudes above sea level thus to verify that there are no air leaks in packages for each vacuum pressure and to observe the performance of the package or several packages in varying heights relative to sea level, and physical accommodations in a given area (inside the chamber), which allows to evaluate the performance of the packages within the real containers during transit to their final destination by applying one or more vacuum pressure cycles having different durations.

These and other objects and advantages of the method for testing the hermetic sealing of packages of the present invention will become apparent to those persons having an ordinary skill in the art, from the following detailed description of the embodiments of the invention.

### DETAILED DESCRIPTION OF THE INVENTION

The method for testing the hermetic sealing of packages of the present invention comprises in a preferred embodiment thereof, the steps of:

a) providing a sealed chamber having means for generating a negative pressure (vacuum pressure) inside said chamber;

b) attaching the one or more packages inside the chamber;

c) submitting the one or more packages to one or more depressurization-pressurization cycles, each comprising submitting the one or more packages to a vacuum pressure and back to atmospheric pressure inside said sealed chamber and registering the maximum and minimum height of the one or more packages as they expand and contract with the pressure changes during the one or more depressurization-pressurization cycles, wherein the vacuum pressure for each cycle is preferable between about 50 mmhg to 220 mmhg. The number of cycles is preferably between about 1 to 50 and the duration of each cycle is preferably between about 1 second to a maximum of 30 seconds, although any person skilled in the art may suggest any number of cycles depending on the characteristics of the packages to be tested, also, any person skilled in the art may suggest that the cycles may have a longer duration depending of the packages to be tested;

d) submitting said one or more packages to a single cycle of depressurization-pressurization at a vacuum pressure of between about 80 to 150 mmhg, for a time of between about 1 to 30 seconds and back to ambient pressure, wherein the vacuum pressure is equal or less than the minimum vacuum pressure achieved during the one or more cycles of step c), and registering the minimum and maximum height of the one or more packages as they expand and contract with the pressure change during the single cycle of depressurization-pressurization of the present step and comparing said values with the minimum and maximum height values obtained in step c)

The measurement of the height of the packages in steps c) and d) may be carried out by any suitable means, for example by electronic means, mechanical means or optical measurement means, such as visual observation, measurement by means of a rule, measurement by laser, among others.

The step c) may have one or more depressurization-pressurization cycles, each having different vacuum pressure values that are lower than the atmospheric pressure, and different durations, thus providing several combinations of cycle numbers, pressure values and duration times depending on the specific needs of each test.

Although in step c) it was described that the vacuum pressures are between about 80 to 150 mmhg, any person skilled in the art may suggest any other vacuum pressure range value, provided that the vacuum pressure used in step c) be equal or less than the minimum vacuum pressure achieved during the one or more depressurization-pressurization cycles of step c). In the same way, although it was described that duration of the depressurization-pressurization cycle of step d)is between about 1 and 30 seconds, any person skilled in the art may suggest a longer duration depending on the specific needs of the test.

In a second embodiment of the invention, there is carried out only one height measurement of the packages at ambient pressure in step c), at the end of the depressurization-pressurization cycles and only one height measurement of the packages at ambient pressure in step d) at the end of the depressurization-pressurization cycle in order to test the integrity of the package.

The second embodiment is useful to simulate, for example, the behavior of one or more packages during transportation of the package(s) during predetermined time periods for each change of vacuum pressure, thus simulating the actual performance of the product in transit, at different heights with respect to sea level in order to verify that there are no air leaks in the packages for each vacuum pressure, and to observe the performance of the package or of several packages in varying heights relative to sea level, and its physical accommodations in a given area (inside the chamber), which allows to observe the performance of several packages within containers during transit to their final destination by varying the vacuum pressure with different time durations of the cycles.

The vacuum chamber that can be used with the method of the present invention may be any suitable vacuum chamber that allows the measurement of the height of one or more packages inside it, by any suitable means, such as electronic, mechanical or optical measurement means, such as visual observation, measurement by means of a rule, laser measurement, among others.

An example of a vacuum chamber that can be used with the method of the present invention comprises a chamber made of any material, including transparent materials, having means for generating a vacuum therein such as a vacuum pump, means for measuring the height of the packaging, such as electronic measurement means, mechanical means or an optical system such as laser measuring, and holding means for the packages that do not affect the height measurements thereof.

The vacuum chamber may have one or more internal compartments which can simulate package storage containers in order to simulate the performance of the packages at various pressures.

Finally it must be understood that the method for testing the hermetic sealing of packages, of the present invention, is not limited exclusively to the embodiments above described and illustrated and that the persons having ordinary skill in the art can, with the teaching provided by the invention, to make modifications to the method for testing the hermetic sealing of packages of the present invention, which will clearly be within of the true inventive concept and of the scope of the invention which is claimed in the following claims.

1. A method for testing the hermetic sealing of one or more hermetic packages, comprising the steps of:
a) submitting the one or more packages to one or more depressurization-pressurization cycles, each comprising submitting the one or more packages to a vacuum pressure and back to atmospheric pressure and registering the maximum and minimum height of the one or more packages obtained during said one or more cycles; and
b) submitting said one or more packages to a single cycle of depressurization-pressurization, wherein the vacuum pressure is equal or less than the minimum vacuum pressure achieved during the one or more cycles of step a), and registering the minimum and maximum height of the one or more packages as they expand and contract with the pressure change during the single cycle of depressurization-pressurization of the present step and comparing said values with the minimum and maximum height values obtained in the previous step.

2. A method for testing the hermetic sealing of one or more hermetic packages as claimed in claim 1, wherein the steps a) and b) are carried out inside a sealed vacuum chamber.

3. A method for testing the hermetic sealing of one or more hermetic packages as claimed in claim 1, wherein in step a), the vacuum pressure for each cycle is from 50 mmhg to 220 mmhg; the number of cycles is preferably between about 1 to 50 and the duration of each cycle is preferably between about 1 second to a maximum of 30 seconds.

4. A method for testing the hermetic sealing of one or more hermetic packages as claimed in claim 1, wherein in step b) the vacuum pressure is between about 80 to 150 mmhg, for a time of between about 1 to 30 seconds.

5. A method for testing the hermetic sealing of one or more hermetic packages as claimed in claim 1, wherein in step a) there is carried out only one height measurement of the packages at ambient pressure at the end of the depressurization-pressurization cycles and only one height measurement of the packages at ambient pressure in step b) at the end of the depressurization-pressurization cycle in order to test the integrity of the package.

6. A method for testing the hermetic sealing of one or more hermetic packages as claimed in claim 1, wherein in step a) and b) are carried out inside a sealed vacuum chamber and includes an additional previous step of attaching the one or more packages inside said sealed vacuum chamber.

7. A method for testing the hermetic sealing of one or more hermetic packages as claimed in claim 1, wherein in step a) and b) the height of the packages may be measured by any suitable means, such as by electronic means, mechanical means or optical measurement means, such as visual observation, measurement by means of a rule or measurement by laser.

8. A vacuum chamber for testing the hermetic sealing of one or more hermetic packages comprising:
an hermetic chamber having means for allowing to see inside said hermetic chamber;
means for generating a vacuum inside said hermetic chamber;
means for attaching the one or more packages to the bottom of said hermetic chamber; and
means for measuring the height of the one or more packages.

9. A vacuum chamber for testing the hermetic sealing of one or more hermetic packages as claimed in claim 8, wherein said hermetic chamber is made of a transparent material.

10. A vacuum chamber for testing the hermetic sealing of one or more hermetic packages as claimed in claim 8, wherein said hermetic chamber has one or more internal compartments.

11. A vacuum chamber for testing the hermetic sealing of one or more hermetic packages as claimed in claim 8, wherein means for measuring the height of the one or more packages comprises a laser measurement system.
